(19) United States
(12) Patent Application Publication
(10) Pub. No.: US 2013/0115418 A1
(43) Pub. Date: May 9, 2013

(54) MULTILAYER RARE-EARTH OXIDE COATINGS AND METHODS OF MAKING

(71) Applicant: CoorsTek, Inc., Golden, CO (US)

(72) Inventors: Elizabeth Young-Dohe, Lakewood, CO (US); Frank E. Anderson, Golden, CO (US); Matthew Simpson, Evergreen, CO (US)

(73) Assignee: CoorsTek, Inc., Golden, CO (US)

(21) Appl. No.: 13/656,463

(22) Filed: Oct. 19, 2012

Related U.S. Application Data
(60) Provisional application No. 61/555,274, filed on Nov. 3, 2011.

(51) Int. Cl. C23C 4/12; B32B 9/04; B32B 33/00

(52) U.S. Cl. 428/141; 427/446; 427/452; 427/454

(57) ABSTRACT

Embodiments relate to a coated substrate and a method of making and using the same. A plasma-spray coated layer may be formed on a substrate, wherein the plasma-sprayed coated layer comprises a rare-earth oxide (e.g., yttrium oxide), a rare-earth fluoride (e.g. yttrium fluoride), or a rare-earth silicate (e.g. yttrium silicate). An exposed surface of the plasma-spray coated layer may be irradiated to form a treated portion of the layer, wherein the treated portion of the layer has a mean spacing of local peaks (S value) between about 100 and 200 microns. A second layer may be formed on the treated portion of the plasma-spray coated layer, wherein the second layer comprises a dielectric material.

### CROSS-REFERENCE TO RELATED APPLICATIONS

This application is a non-provisional of and claims the benefit and priority of U.S. Application No. 61/555,274, filed on Nov. 3, 2011, which is hereby incorporated by reference in its entirety for all purposes.

### BACKGROUND OF THE INVENTION

Semiconductor devices are frequently fabricated in a chamber. Layers may be deposited onto a substrate by, e.g., sputtering a compound onto the substrate. The layers may be shaped into specific geometries by etching the layers, which may involve introducing a corrosive gas into the chamber. Thus, surfaces inside the chamber (e.g., inner surfaces of a chamber's housing) may be exposed to sputtered compounds and etchants. This exposure may lead to oxidation and/or erosion of these surfaces. This oxidation or erosion may weaken the underlying structures. A second complication that can occur is the redeposition of the material of the chamber surface onto the substrate being processed. This can lead to imperfections: the redeposition of chamber surface material may weaken the bond between a layer and the substrate, or it can provide unwanted masking in an etch process. A third problem results from chemical effects. Generally semiconductor deposition or etching processes involve free radicals. The concentration of radicals is affected by recombination reactions on chamber surfaces. If the nature of these surfaces changes (as it might if different compounds are sputtered to the surfaces), then the concentration of radicals in the chamber may change. In turn, this may produce undesirable changes in etch rate or deposition.

One way to protect chamber surfaces exposed to the sputtered compounds and etchants is to apply a “seasoning” layer of material that shields the underlying chamber. These seasoning layers may be applied before a series of deposition, sputtering, and/or etching cycles are performed in the chamber, and are then removed and redeposited before the seasoning layer itself starts to flake and contaminate the substrate. Because the seasoning layers are periodically removed and redeposited, there is a balance between seasoning layers that are very non-reactive but potentially difficult to replace, and layers that are more reactive but easier to replace.

While a seasoning coating may reduce the probability that sputtering particles and corrosive process gases will damage the walls of the chamber, drop unwanted particles on the substrate or modify process kinetics, these benefits need to be balanced by the reactivity and ease of replacing the coating itself. These and other problems are addressed in the present application.

### BRIEF SUMMARY OF THE INVENTION

In one embodiment of the invention, processing equipment (e.g., a semiconductor fabrication chamber) is protected against corrosion, abrasion and/or oxidation by applying a first coating to exposed surfaces of the equipment. This first coating may include, without limitation, a rare-earth oxide, such as yttrium oxide, a rare-earth fluoride, such as yttrium fluoride, a rare-earth silicate, such as yttrium silicate, and/or a rare-earth oxyfluoride, such as erbium oxyfluoride. This coating may prevent gases and particles from processing from coming into contact with a base substrate of the equipment. An exposed surface of the coating may be treated (e.g., by irradiating the surface), to control a roughness/smoothness of the coating. The treatment may be controlled such that the treated surface is sufficiently rough to allow a second layer to securely adhere to the surface but sufficiently smooth to prevent pieces of the coating from fragmenting from the layer into a processing chamber.

After the first coating has been treated, a second layer (e.g., a dielectric layer) may be formed on the coating. This layer is sometimes referred to as a seasoning layer or coating. Processing may then be performed, and the coating and second layer may protect the equipment from being damaged based on exposure to processing gases or materials. After one or more uses, the equipment may be exposed to another material that reacts with and removes the second layer, the second layer being a seasoning layer. A replacement second layer may then be deposited on the underlying treated surface. In this manner, an exposed surface of the equipment may be routinely replaced to continue to protect the equipment and maintain cleanliness and precision associated with the processing.

Embodiments may include methods of forming a multilayer coating on a substrate. The method may include the step of forming a plasma-spray coated layer on the substrate, where that plasma-sprayed coated layer may include a rare-earth oxide (e.g. yttrium oxide), a rare-earth fluoride (e.g. yttrium fluoride), or a rare earth silicate. The method may further include the step of irradiating an exposed surface of the plasma-spray coated layer (e.g., by exposing the surface to a beam of laser light) to form a treated portion of the layer. The treated portion of the layer has a mean spacing of local peaks (an S value) between about 15 and 200 expressed in units of the surface roughness Rₐ. A second layer may be formed on the treated portion of the plasma-spray coated layer, where that second layer may include a dielectric material such as silicon oxide.

Embodiments may further include a coated surface comprising: a plasma-spray coated layer on a substrate (e.g., a component of a semiconductor fabrication apparatus), wherein the plasma-spray coated layer comprises a rare-earth oxide (e.g., yttrium oxide), a rare-earth fluoride (e.g. yttrium fluoride), or a rare earth silicate. The plasma-spray coated layer may include a treated portion facing a contact surface between the plasma-spray coated layer and the substrate. The treated portion of the layer may be formed by irradiating the plasma-spray coated layer. The treated portion of the plasma-spray coated layer may further have an S value between about 15 and 200 expressed in units of the surface roughness Rₐ. The coated surface may further include a second layer comprising a dielectric material, such as silicon oxide.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 shows a flowchart with selected steps in a method of forming a multilayer coating according to embodiments of the invention.

FIG. 2 shows an example of a processing chamber coated with multiple layers.

FIGS. 3A-3B show examples of an untreated rare-earth oxide coating.

FIGS. 3C-3F show examples of a treated rare-earth oxide coating.

### DETAILED DESCRIPTION OF THE INVENTION

Frequently, devices such as semiconductors, MEMS devices, chips, etc. are manufactured in one or more processing chambers. As described in greater detail below, a chamber includes a housing to allow for a chemical composition, temperature and pressure in the chamber to be tightly controlled. Various layers may be deposited onto a wafer, e.g., through a chemical vapor deposition (CVD) process. During this process, a chemical product may be formed based on a reaction or decomposition of precursors, thereby forming a layer of the product on the wafer. Subsequently, the layer may be etched, e.g., by forming a mask by applying, exposing and developing photoresist on the layer, and then introducing an etchant into the chamber to etch away the unprotected portions of the layer.

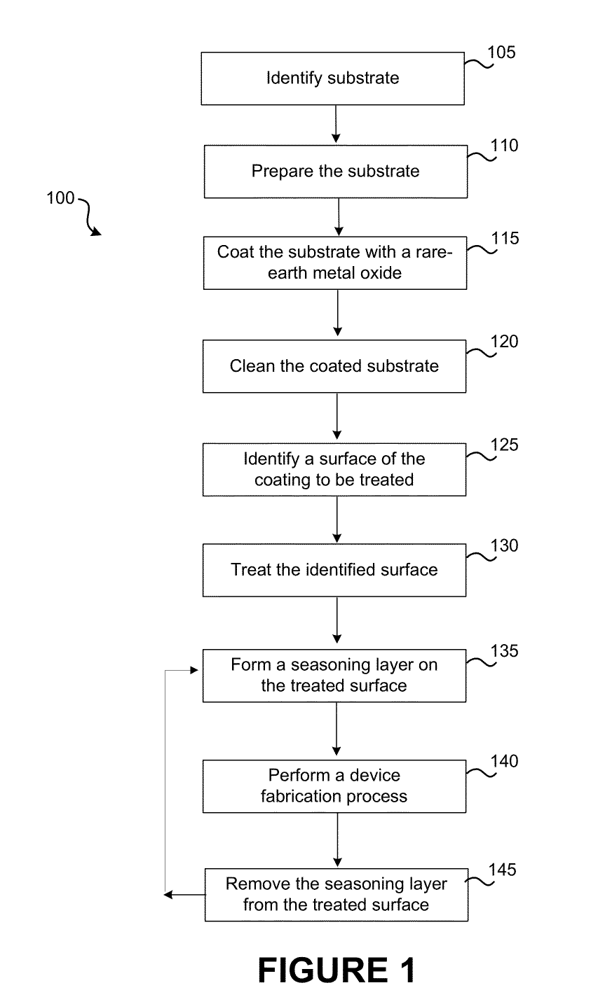

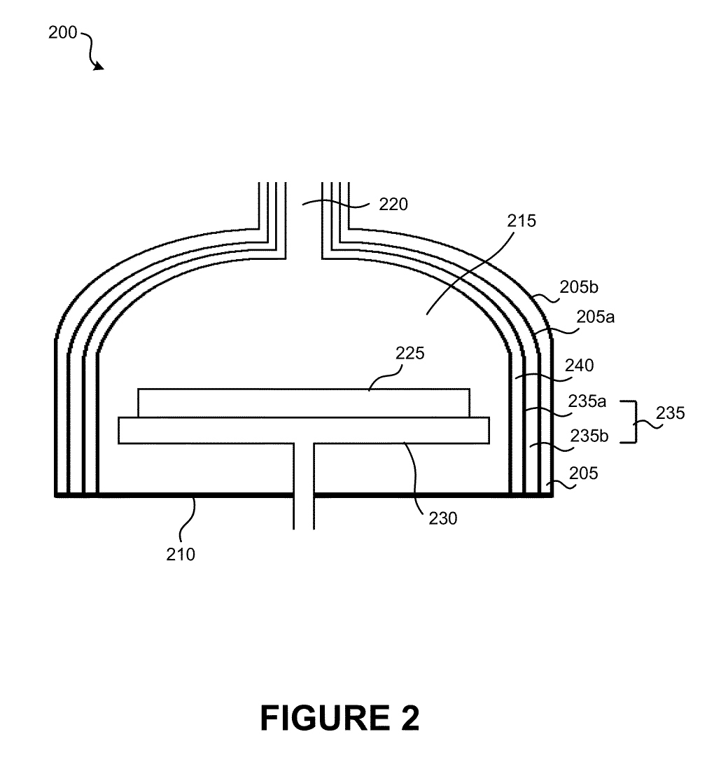

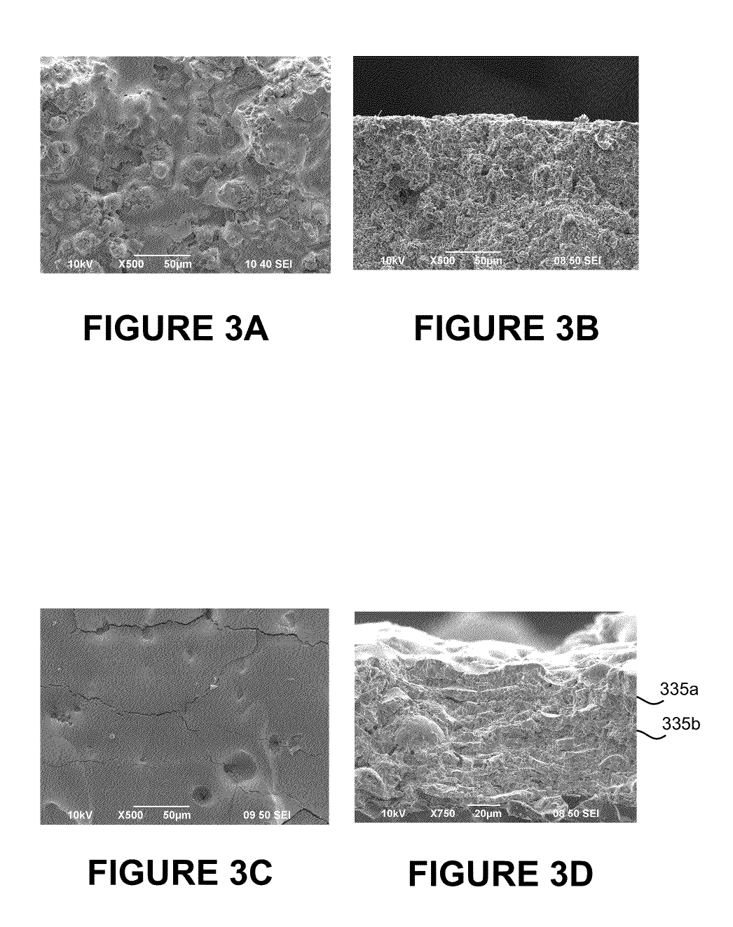

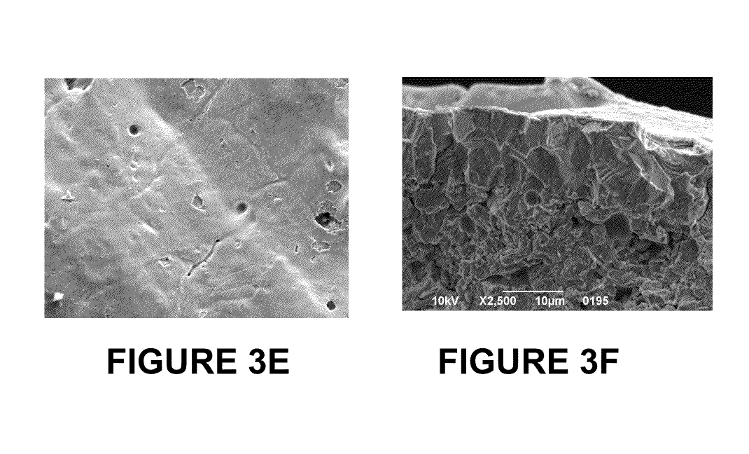

While this process exposes a wafer to desired chemicals, processing equipment is also exposed to these chemicals. Exposure to materials used to make layers on the wafer (e.g., gas precursors) may result in a thin film of similar composition being formed on exposed surfaces of equipment. After prolonged use, this film may increase in thickness, and crack (e.g., following a change in temperature in the chamber). Small pieces of the film (sometimes referred to as particle “adders”) may then break away and fall onto a wafer, causing defects in the device being fabricated. Additionally, exposure to etching precursors may corrode and damage the equipment. Devices and methods described below allow processing equipment to be protected from corrosion and damage, while simultaneously allowing for the equipment to be cleaned to remove film build-up, thereby improving fabrication quality. As explained in more detail below, FIG. 1 shows an exemplary method for protecting processing equipment is presented, by coating the equipment with a coating and treating a surface of the coating, such that a second removable layer may adhere to the surface. FIG. 2 shows a diagram illustrating a protected processing chamber, wherein an inner surface of the chamber is coated with a coating layer (e.g., comprising a-metal oxide), the surface of the coating is treated to obtain a desired roughness, and a removable seasoning layer (e.g., comprising a dielectric) is deposited onto the treated surface. FIGS. 3A-3F show examples of treated and untreated yttria layers.

FIG. 1 shows a flow chart of a method 100 of protecting processing equipment. At 105, a substrate is identified. The substrate may include part of the processing equipment, which could be equipment used during deposition and/or etching processes, semiconductor fabrication processes, MEMS fabrication processes, etc. The equipment may include one or more components located within a process chamber and/or a chamber itself. For example, the substrate may include all or part of a chamber housing, such as one or more walls defining an interior space in the chamber. As other examples, the substrate may include all or part of: a worktable, a gas inlet, a showerhead, an exhaust pipe, a heating element, a base wall, etc. The substrate may comprise a ceramic material and/or a metallic material (e.g., aluminum, nickel, titanium, steel, etc.). The substrate is expected to be contacted by corrosive, oxidizing, or other materials used during the processing of a device. A substrate may include one or more components of a single piece of equipment, all components of a single piece of equipment, or one, some or all components of multiple pieces of equipment (e.g., all pieces of equipment exposed to processing chemicals during device fabrications).

At 110, the substrate is prepared (e.g., for a coating deposition at 115). The preparation may improve adhesion of a subsequently deposited layer (e.g., a coating layer deposited at 115) to the substrate. Preparation may include, e.g., etching, grit-blasting the substrate and/or cleaning (e.g., ultrasonically cleaning) the substrate. The cleaning may remove undesirable particles and/or residual grit material, which may otherwise cause delamination at an interface between the substrate and an adjacent layer.

At 115, the substrate is coated with a coating, thereby forming a coating layer on the substrate. The coating may comprise a rare-earth oxide, a rare-earth fluoride, or a rare-earth silicate and/or a material at least with good resistance to corrosion (e.g., to halogen corrosion, and/or to plasma erosion). The material's resistance to corrosion may be greater than the resistance of the substrate or oxides not comprising a rare-earth element. The rare-earth oxide may include an oxide of an element in the Lanthanide Series (atomic numbers 57-71), yttrium, or scandium. As one example, the substrate is coated with yttrium oxide.

Rare-earth species can be interchangeably referred to as (1) rare-earth elements or (2) rare-earth metals. Similarly, the corresponding oxides, fluorides, silicates, etc., of rare-earth species may be referred to as rare-earth oxides or rare-earth metal oxides, rare-earth fluorides or rare-earth metal fluorides, rare-earth silicates or rare-earth metal silicates, and so on. In this Application, the terms rare-earth elements and rare-earth metals (and their associated oxides, halides, minerals, salts, etc.) describe the same rare-earth species.

The coating may include one or more rare-earth oxides or rare-earth fluorides and one or more other materials (e.g., non-rare-earth oxides). The coating may include at least 50%, 70%, 90% or 95% rare-earth oxide or rare-earth fluoride. The coating may include less than 50%, 20%, 10% or 5% of other materials (e.g., silicon dioxide). In some instances, the coating does not include more than 10 ppm of any 1^{st} row transition element.

The coating may be deposited by spraying (e.g., plasma-spraying, atmospheric plasma spraying, low pressure plasma spraying, water-stabilized plasma spraying, detonation spraying, etc.) the oxide or material onto the substrate. In one embodiment, an oxide or above-described material is powderized (e.g., such that resulting particles are between about 5-80 microns). This powder may be melted (e.g., by introducing the powder into a plasma plume) and sprayed onto the substrate. Coating parameters (e.g., spray parameters and/or coating compositions) may be selected to produce a coating layer with: a high purity (e.g., less than 20 ppm of each row transition element excluding Sc or Y), good adhesion strength, low unmelt count (explained below), low porosity, high resistance to etchants (e.g., HCl), low surface roughness, desirable color (e.g., white or light in color in some instances, or black or dark in color in other instances), and/or high deposition efficiency.

All or part of the substrate may be coated. For example, at least or approximately all surfaces of the substrate that are exposed within a chamber may be coated. A chamber-facing surface of the substrate (e.g., a chamber housing) may be coated with the coating. In one embodiment, a coating material is sprayed onto processing chamber components, which may or may not include chamber housing and/or non-housing processing equipment (e.g., a worktable). The substrate may be coated such that the resulting coating has a thickness of greater than about 50 microns, 100 microns, 150 microns, 200 microns or 500 microns. The coating may have, e.g., a porosity of about 0-5%, 1-7% or 3-5%.

At 120, the coated substrate is prepared. The preparation may be similar to the preparation at 110. In some embodiments, preparing the coated substrate comprises cleaning the coated substrate. This preparation may remove loose particles from the surface. Further, the deposition of the coating layer may have resulted in overspray, which may result from coating powder that did not traverse through a plasma source (therefore not melting) before reaching the substrate. Similarly, the deposition may have resulted in formation of unmelts on a substrate surface, which may result from coating powders that did traverse through a plasma source but had not fully melted before reaching the substrate. Cleaning the substrate may remove some or all of the unmelts and overspray. Preparation may include, e.g., wiping the substrate with clean cloth pads or cleaning (e.g., ultrasonically cleaning, spraying with CO₂ particles or spraying with an aqueous solution) the substrate, etc. Other details regarding potential cleaning techniques are disclosed in U.S. Pat. No. 8,067,067, which is hereby incorporated by reference in its entirety for all purposes.

At 125, a surface for treating is identified. The surface may comprise a surface of the coating on the substrate. The identified surface may comprise a surface on the coated substrate that is or will be configured to face an interior of a processing chamber and/or to be exposed to processing chemicals. For example, a chamber-housing substrate may have a chamber-facing surface and an outwards-facing surface, the chamber-facing surface being substantially opposite from the outwards -facing surface. A coating layer may be deposited on the chamber-facing surface at 115. The coating layer may also include a chamber-facing surface and an opposite outwards -facing surface. The substrate's chamber-facing surface may be adjacent to, and form an interface with, the coating's outwards-facing surface. The identified surface may include, or consist of, the coating's chamber-facing surface. The surface may or may not include a planar surface.

Identification of the surface may thereby identify a size (e.g., surface area and/or layer depth) and material of the surface to be treated. This identification may allow treatment settings (e.g., a program speed and/or power settings of a laser) to be appropriately configured.

At 130, the identified surface is treated, thereby forming a treated coating layer on an underlying base coating sub-layer. Treating may include irradiating the surface with a laser, such as a YAG, infrared or CO₂ laser. The laser may comprise infrared laser light and/or have a power intensity of about 30 watts to about 80 or 120 watts and/or a raster rate of about 2 cm/second to about 20 cm/second. Laser irradiation may include scanning across one or more regions of the identified surface. Precise laser paths, irradiation regions, and/or laser settings (e.g., speed, power, etc.) may be determined in an effort to not impart too much stress on the coated substrate but simultaneously ensure that most, nearly all or all of the identified surface receives a desired treatment (e.g., to produce a treated coating sub-layer with a desired depth and properties). In one instance, irradiating the surface comprises scanning a laser across a plurality of straight lines (e.g., multiple horizontal lines at various vertical locations along the identified surface). In one instance, irradiating the surface comprises scanning across the surface in a single path (e.g., including multiple non-parallel path segments). The laser may be set to have a pulse frequency and its focal point may be set to have linear speed such that one may attain a spatial resolution of about 300-1000 dpi, about 400-800 dpi or about 600 dpi. In one embodiment, treatment includes irradiating a surface with a laser operated at about 40% speed and about 100% power.

The treatment may be one that increases a density and/or alters a smoothness of the surface. This smooth, dense surface may increase the coating's resistance, e.g., to corrosion or erosion.

A treatment type (e.g., type of irradiation) and treatment characteristics (e.g., an irradiation time, laser settings, laser-scan paths, etc.) may be identified to result in desired roughness/smoothness properties associated with a surface of the treated coating sub-layer. For example, extended or pronounced irradiation may weaken the substrate and/or may inhibit a subsequently deposited layer from strongly adhering to the surface of the treated coating sub-layer and/or may cause the coating to delaminate from a substrate due to induced stress. However, insufficient irradiation may cause coating particles or particles from thin films formed on the coating (as a result of exposure to processing chemicals) to flake off and interfere with device fabrication. In some instances, the treatment results in a treated coating sub-layer with a thickness of about 0.5-20 microns. The treated coating sub-layer may have a porosity of less than about 2%. The treated coating sub-layer may be a different color than the original coating. For example, treatment with a laser may lighten or darken the color (e.g., by using a CO₂ or a near infrared laser). The base coating sub-layer may have properties (e.g., roughness and/or porosity properties) similar to those identified for the original coating layer. It may be helpful to flood the treated area with a gas that is not air. Carbonaceous gases such as methane may be blown into the region to react with the coating during processing. Typical concentrations of gas are 2-15% although one could use up to 100% of carbonaceous gas, or down to 0.1%. In some instances, the substrate may be coated with a carbonaceous solid or liquid that forms gas as the laser scans over it. Using this means, the number of atoms per unit area of the coating can be less than ten times the number of atoms in the coating to be treated, thereby increasing treatment efficacy.

The treatment may affect physical properties (e.g., related to roughness, peaks, valleys, etc.) of part of the coating layer (e.g., a surface and/or top sub-layer). For example, when measured using a Mahr MarSurf PS1 roughness measuring instrument with a traverse length of 5.6 mm, a cut-off of 0.8 mm and 5 sampling lengths (n=5), a treated portion (e.g., a treated sub-layer or a surface of a treated sublayer) may have an Ra (arithmetic mean roughness) of about 1-4 microns, Rz (mean peak to valley height) of about 5-25 microns, Rp (maximum profile peak height) of about 3-10 microns, S (mean spacing of local peaks) of about 50-300 microns, RPc (peak count) of about 20-65/cm, and/or R (mean depth of roughness motifs) of about 4-15 microns. As another example, a treated portion may have an average Ra value between 1-4 or 1.5-2.5 microns, an average Rz value between 5-25 or 8-15 microns, an average Rp value between 10-18 or 13-17 microns, an average R3z value between 2-10 or 3.5-7.5 microns, an average RPc value between 20-80/cm or 25-65/cm, an average S value between 75-375 or 75-225 microns, and/or an average R value between 4-14 or 4-10 microns. Because the variance of individual measurements is usually high, roughness parameters can be determined based on measurements collected over multiple locations (e.g., over at least 12 randomly chosen locations). In addition, a few scale-invariant parameters such as Rsm/Rmax (mean width of profile elements divided by maximum roughness depth), Rsm/Rp (mean width of profile elements divided by maximum profile peak height), Rsm/Ra (mean width of profile elements divided by arithmetic mean roughness), and S/Ra (mean spacing of local profile peaks divide by arithmetic mean roughness) can be considered to account for frequency and amplitude variation in the roughness measurements of the sample.

Roughness variables can be calculated using the techniques described in E. S. Gadelmawla et al., Journal of Materials Processing Technology 123 (2002) 133-145, which is hereby incorporated by reference in its entirety for all purposes. For example, S values can be calculated by calculating an average spacing between local peaks. Local peaks can be identified as the highest part of a profile measured between two adjacent minima, so long as the vertical distance between neighboring peaks was at least 10% of the Rt of the profile.

Treating a coating may (e.g., statistically) decrease Ra, Rz, Rp, RPc and R values and/or (e.g., statistically) increase S values associated with the treated portion of the coating. In some embodiments, the table below shows an approximate lower limit, an approximate mean, an approximate upper limit, an approximate standard deviation and/or an approximate range for one or more of the identified variables when measured using a Mahr MarSurf PS1 roughness measuring instrument with a traverse length of 5.6 mm, a cut-off of 0.8 mm and 5 sampling lengths (n=5). The “None” Treatment rows may indicate properties corresponding to a coating as initially applied with no treatment. The “Standard” Treatment may indicate properties corresponding to a treated coating sub-layer. In some embodiments, treatment of the coating is confined to standard treatment. Refraining from excess treatment and maintaining surface roughness values below the standard range for Ra, Rz, Rp, Rpc, and R and above the standard range for S may allow a subsequently applied seasoning layer to apply to a treated surface and/or may prevent the coating from delaminating from a substrate due to induced stress.

| Variable | Treatment | Mean | StDev | Minimum | Maximum | Range |
|---|---|---|---|---|---|---|
| Ra (μm) | None | 4.36 | 0.34 | 3.11 | 5.11 | 2.00 |
| | Standard | 2.08 | 0.41 | 1.42 | 3.59 | 2.17 |
| Rz (μm) | None | 25.7 | 1.83 | 21.6 | 29.1 | 7.5 |
| | Standard | 11.7 | 2.99 | 6.5 | 23.3 | 16.8 |
| Rp (μm) | None | 13.47 | 1.35 | 10.6 | 16.0 | 5.4 |
| | Standard | 5.33 | 1.29 | 2.88 | 9.28 | 6.4 |
| RPc (/cm) | None | 108 | 9.41 | 85 | 128 | 43 |
| | Standard | 40 | 12.2 | 20 | 80 | 60 |
| S (μm) | None | 54.4 | 3.61 | 48 | 67 | 19 |
| | Standard | 157 | 65.4 | 75 | 374 | 299 |
| R (μm) | None | 17.0 | 1.63 | 13.4 | 20.1 | 6.7 |
| | Standard | 7.74 | 1.96 | 4.3 | 13.8 | 9.5 |
| Rsm/Rmax | None | 5.385 | 0.768 | 3.780 | 7.114 | 3.334 |
| | Standard | 21.29 | 11.50 | 4.33 | 64.11 | 59.78 |
| Rsm/Rp | None | 11.992 | 1.938 | 8.794 | 16.807 | 8.012 |
| | Standard | 63.46 | 35.65 | 10.000 | 186.49 | 176.49 |
| Rsm/Ra | None | 37.039 | 5.208 | 28.049 | 54.896 | 26.846 |
| | Standard | 170.49 | 66.86 | 34.31 | 360.08 | 325.77 |
| S/Ra | None | 12.583 | 1.536 | 10.625 | 19.626 | 8.637 |
| | Standard | 77.92 | 40.21 | 18.45 | 218.79 | 200.34 |

At 135, a seasoning layer is formed on the treated surface. The seasoning layer may be formed while, or as part of, a seasoning of a processing chamber. The seasoning layer may comprise and/or consist of, e.g., a dielectric material, silicon, silicon oxide or silicon dioxide. The seasoning layer may be formed, e.g., using a CVD process. For example, silane and molecular oxygen may be introduced into a chamber to form a silicon dioxide layer on a treated surface of a chamber-facing treated and coated surface of a chamber housing. The seasoning layer may be deposited on all or part of the treated surface.

At 140, a device fabrication process is performed. The device may include, e.g., a semiconductor, a MEMS device, a chip, etc. The fabrication process may include, e.g., one, more or substantially all manufacturing processes required to produce the device. The fabrication process may include a deposition process (e.g., to deposit a layer on a wafer) and/or an etching process. The fabrication process may be performed within a processing chamber, and the treated and seasoned surface may also be within the processing chamber. Temperatures, pressures and/or intra-chamber compositions may be controlled and/or varied during the process. Thus, the treated and seasoned surface may be exposed to, e.g., layer precursors, spray particles, etchants, high temperatures, high pressures, etc.

At 145, the seasoning layer is removed from the treated surface. The removal of the seasoning layer may be part of a chamber-cleaning process. The removal may occur after one or more devices were fully or partly fabricated in manner such that the treated surface was exposed to processing-related chemicals. The coating may be partly, substantially or fully removed by introducing, e.g., a gas or liquid including a halogen or oxygen (e.g., HCl, SF₆ or H₂O) into the chamber.

As shown in FIG. 1, 135-145 may be repeated, such that a layer is repeatedly removed and replaced in between one or more processing steps. For example, a processing chamber may be cleaned and re-seasoned in between processing a first device and a second device or in between processing a first batch of devices and a second batch of devices. Thus, a seasoning coating on equipment surfaces exposed to an interior volume of a processing chamber may be routinely re-applied, thereby decreasing the risk that a device being fabricated within the chamber is damaged by extraneous particles.

FIG. 2 shows a cross-section of an example coated processing chamber 200. Features shown in the figure are not to scale. Processing chamber 200 may include a housing 205, which may define side and top boundaries of chamber 200. Housing 205 may be substantially solid and include substantially curved and/or planar surfaces. In some instances, housing 205 comprises a cylindrical base and a dome top. Housing 205 may be directly adjacent to or include a base wall 210. Housing 205 and base wall 210 may or may not include similar or identical material compositions. Housing 205 and/or base wall 210 may comprise a ceramic and/or metallic material (e.g., titanium, steel, nickel, aluminum, etc.). Housing 205 may include a chamber-facing surface 205a and an outwards-facing surface 205b. The chamber-facing surface 205a may be substantially opposite from the outwards-facing surface 205a. Chamber-facing surface 205a may be closer to a center or interior of chamber 200 than outwards-facing surface 205b.

Housing 205 may define an interior volume 215. Interior volume 215 may be separated from an external environment, such that gas composition, pressure and/or temperature in volume 215 can be controlled. One or more gases and/or materials to be deposited may be introduced to volume 215 through one or more gas inlets or showerhead 220. A device 225 (e.g., a semiconductor, a chip, a MEMS, etc.) may be supported by a pedestal 230 and subjected to processing (e.g., depositions, etching, etc.) in interior volume 215.

Chamber-facing surface 205a of housing 205 may be coated with coating layer 235. Coating layer 235 may have a thickness of at least about 50 microns and/or less than about 200 microns. Coating layer 235 may include and/or consist of, e.g., a rare-earth oxide, such as yttrium oxide or yttrium silicate, a rare-earth fluoride, such as yttrium fluoride. Coating layer 235 may include an underlying base coating sub-layer 235b and a treated coating sub-layer 235a. Treated coating sub-layer 235a may be closer to an interior or center of chamber 200 than base coating sub-layer 235b. Treated coating sub-layer 235a may be more dense, smoother, more resistive to corrosion, more resistive to abrasion, and/or less porous than base coating sub-layer 235b and/or than substrate 205. Treated coating sub-layer 235a may have been formed by melting (e.g., by irradiating) a surface portion of coating layer 235 (e.g., using a YAG and/or CO₂ laser).

Coating layer 235 may be coated with a seasoning layer 240. Seasoning layer 240 may include a dielectric material, such as silicon dioxide. Seasoning layer 240 may configured to withstand fabrication processes (e.g., depositions and/or etchings as applied to device 225), yet still be removable (e.g., by introducing a halogen-containing gas, such as HF, into the chamber).

Thus, in one instance, set-up processing may initially coat housing 205 with coating layer 235. Coating layer 235 may be treated, such that treated coating sub-layer 235a forms at a chamber-facing surface of the layer. Seasoning layer 240 may be deposited on treated coating sub-layer 235a. Device 225 is introduced to chamber 200 and processing (e.g., layer deposition and etching is performed). Device 225 is removed from chamber 200, and seasoning layer 240 is removed (e.g., by introducing a gas into the chamber). A new seasoning layer 240 is deposited on treated coating sub-layer 235a, the same or a new device 225 is re-inserted into chamber 200, and another processing step is performed. The process may continue in this manner—repeatedly re-applying a seasoning layer, processing devices, and removing the seasoning layer.

Notably, coating layer 235 and seasoning layer 240 may be applied to more or less surfaces as compared to those shown in FIG. 2. For example, in one embodiment, a coating layer is also or alternatively deposited on pedestal 230 and/or base wall 210. This coating layer may be treated and at least partly covered by a seasoning layer. As another example, the coating layer 235 and/or seasoning layer 240 may not extend into showerhead 220.

### Experimental

Example 1: FIGS. 3A-3D show example of a rare-earth oxide coatings, which are approximately 100 microns thick In this instance, the coating comprises yttria. As sprayed, the coating had a porosity of about 3-5%. FIGS. 3A and 3C show a top view of a coating's surface, and FIGS. 3B and 3D show a cross-sectional side view of a coating (e.g., through a depth of the coating). FIGS. 3A and 3B show an un-treated coating, and FIGS. 3C and 3D show a treated coating. In this instance, treatment comprised irradiating the top surface of the coating with a 75 W CO₂ laser at 40% speed (about 8 cm/second) and 100% power focused to a spot about 100 μm in diameter. As shown, the top surface of the coating was smoother after treatment. Further the effect of the treatment extended beyond the surface, thereby affecting a top portion of the layer (a treated sub-layer 335a) but not a bottom portion of the layer (a base sub-layer 335b), as shown in FIG. 3C. Treated sub-layer 335a was more dense, more uniform, and less porous than the original coating or than base sub-layer 335b under the treated sub-layer. This dense treated sub-layer may prevent corrosive or abrasive processing chemicals from damaging an underlying coated substrate. However, extensive treatment may result in a surface so smooth to as impair adhesion of a layer (e.g., a seasoning layer) subsequently deposited on the surface.

Example 2: A large ceramic disk was coated with yttria using thermal plasma spray. The coating was about 100 μm thick and contained about 3% porosity.

A CO₂ laser beam was scanned across the disk using the following conditions:

| | |
|---|---|
| Equipment | Epilog Legend 36XT |
| Power | 75 W |
| Scan speed | 80 cm/s |
| Spot size | ~100 um |
| Gas flow | 20 slm |
| Gas composition | 10% CH₄, bal. Ar |

The gas was injected coaxially with the beam. After this process, the initially white coating turned black. Inspection in an electron microscope of fractured sections showed melting of the top surface to a depth of about 10 μm. The same area was then treated with a Q-switched Nd:YAG laser in open air using the following conditions:

| | |
|---|---|
| Equipment | Lumonics LightWriter |
| | SPe |
| Power | 40 W |
| Scan speed | 15 cm/s |
| Spot size | ~100 um |
| Pulse rate | 1.5 kHz |

The coating remained black. Inspection of a cross-section in an optical microscope indicated that the black color penetrated at least 5 μm down from the surface. FIGS. 3E and 3F show respectively the top surface of the coating after this treatment and a fractured section of the coating. The window was immersed in an ultrasonic bath and treated for 90 minutes, at the end of which the release rate of 0.1 μm particles was only half that of a comparable untreated window. This illustrates the benefit of the laser treatments in removing particles.

Example 3: A set of 25 mm diameter ceramic disks was coated with yttria using thermal plasma spray in a manner similar to Example 2. Again, the coating was about 100 μm thick and contained about 3% porosity. A CO₂ laser beam was scanned across the disk using the following conditions, which are similar to Example 2:

| | |
|---|---|
| Equipment | Epilog Legend 36XT |
| Power | 75 W |
| Scan speed | Variable |
| Spot size | ~100 um |
| Gas flow | 20 slm |
| Gas composition | 10% CH₄, bal. Ar |

Half of the coupons were scanned at 60 cm/s and half at 80 cm/s. Four of the coupons were subjected to the following crack measurement procedure. At least 3 randomly chosen locations on each coupon were imaged in the SEM at 1000× (field 1280×960 pixels, scale 1 pixel=0.104 μm).

Each field was reviewed for cracks. The maximum crack width per field was measured from the image using the following criteria:
measurements were done away from chips, pores and lumps in the coating
the width needed to be reasonably constant for 3 or more crack widths along the crack, to avoid counting a chip as a crack.

For each coupon, the maximum crack width (averaged over fields) was found to be greater than 0.7 μm. The coupons were then treated with a Q-switched Nd:YAG laser in open air using the following conditions:

| | |
|---|---|
| Equipment | Lumonics LightWriter |
| | SPe |
| Power | 40 W |
| Scan speed | 15 cm/s |
| Spot size | ~100 um |
| Pulse rate | 1.5 kHz |

The maximum crack width was measured according to the procedure described above, and was found to be less than 0.5 μm. The adhesion strength of the coupons processed at 60 cm/s and at 80 cm/s was measured using the method of ASTM C633 and found to exceed 40 MPa on average for each speed. This comfortably exceeds the minimum adhesion strength of ˜15 MPa considered necessary in the industry for satisfactory coatings.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method of forming a multilayer coating on a substrate, the method comprising:
forming a plasma-spray coated layer on the substrate, wherein the plasma-sprayed coated layer comprises a rare-earth oxide, a rare-earth fluoride or a rare-earth silicate;
irradiating an exposed surface of the plasma-spray coated layer to form a treated portion of the layer, wherein the treated portion of the layer has a mean spacing of local peaks (S value) between about 100 and 300 microns; and
forming a second layer on the treated portion of the plasma-spray coated layer, wherein the second layer comprises a dielectric material.

2. The method of claim 1, wherein the irradiating of the exposed surface of the plasma-spray coat layer comprises exposing the surface to a beam of laser light.

3. The method of claim 2, wherein the laser light comprises infrared laser light having a power intensity of about 30 watts to about 80 watts.

4. The method of claim 3, wherein the laser light has a wavelength of 10.6 μm.

5. The method of claim 2, wherein the laser light irradiating the exposed surface has a raster rate of about 2 cm/second to about 20 cm/second.

6. The method of claim 1, wherein the initially deposited plasma-spray coated layer has an S value between about 45 microns and 75 microns.

7. The method of claim 1, wherein the dielectric material of the second layer comprises silicon oxide.

8. The method of claim 1, wherein the forming of the second layer comprises a chemical vapor deposition of the dielectric material on the treated portion of the plasma-spray coated layer.

9. The method of claim 1, wherein the rare-earth oxide comprises yttrium oxide (Y₂O₃).

10. The method of claim 1, wherein the plasma-spray coated layer has a thickness of about 50 microns to about 200 microns, and the treated portion of the layer has a thickness of about 0.5 microns to about 20 microns.

11. The method of claim 1, wherein the method comprises roughening the substrate prior to the forming of the plasma-spray coated layer on the substrate.

12. The method of claim 1, further comprising:
performing a semiconductor-fabrication process, thereby exposing the second layer to a fabrication chemical;
removing the second layer; and
forming a new second layer on the treated portion of the plasma-spray coated layer.

13. A coated surface comprising:
a plasma-spray coated layer on a substrate, wherein the plasma-spray coated layer comprises a rare-earth oxide, a rare-earth fluoride or a rare-earth silicate;
a treated portion of the plasma-spray coated layer facing opposite a contact surface between the plasma-spray coated layer and the substrate, wherein the treated portion of the layer is formed by irradiating the plasma-spray coated layer, and wherein the treated portion of the plasma-spray coated layer has a mean spacing of local peaks (S value) between about 100 and 200 microns; and
a second layer formed on the treated portion of the plasma-spray coated layer, wherein the second layer comprises a dielectric material.

14. The coated surface of claim 13, wherein an untreated portion of the plasma-spray coated layer has an S value between about 45 and 75 microns.

15. The coated surface of claim 13, wherein the substrate comprises a component of a semiconductor fabrication apparatus.

16. The coated surface of claim 15, wherein the component of the semiconductor fabrication apparatus comprises an interior wall of a plasma-using semiconductor fabrication chamber.

17. The coated surface of claim 13, wherein the rare-earth oxide comprises yttrium oxide (Y₂O₃).

18. The coated surface of claim 13, wherein the plasma-spray coated layer that has not been treated has an average porosity that is statistically greater than the an average porosity of the treated portion of the plasma-spray coated layer.

19. The coated surface of claim 13, wherein the dielectric material of the second layer comprises silicon oxide.
